(19) United States
(12) Patent Application Publication
(10) Pub. No.: US 2009/0300946 A1
(43) Pub. Date: Dec. 10, 2009

(54) ANTISTATIC POLYURETHANE

(75) Inventors: Gitta Egbers, Lemfoerde (DE); Marco Ortalda, Torino (IT); Markus Templin, Lemfoerde (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/278,630

(22) PCT Filed: Jan. 30, 2007
(86) PCT No.: PCT/EP07/50857

§ 371 Date: Oct. 21, 2008

(30) Foreign Application Priority Data
Feb. 7, 2006 (EP) 06101354.6

(51) Int. Cl. A43B 13/00; C08L 75/04; C08K 5/3445; C08K 5/31; C08K 5/49; C08K 5/3432; C08G 18/00

(52) U.S. Cl. 36/103; 524/589; 524/106; 524/195; 524/115; 524/99; 521/155; 36/25 R

(57) ABSTRACT

The invention relates to an antistatic polyurethane which comprises an antistatic additive comprising an ionic liquid and a process for producing such an antistatic polymer. The invention further relates to an antistatic shoe sole comprising an antistatic polyurethane according to the invention and the use of an ionic liquid as antistatic additive for polyurethane.

The invention relates to a polyurethane which comprises an ionic liquid. The invention further relates to a process for preparing such a polyurethane, rollers, floor coverings automobile interior components, films and antistatic shoe soles comprising a polyurethane according to the invention and the use of an ionic liquid as antistatic additive.

Further embodiments of the present invention may be found in the claims, the description and the examples. It goes without saying that the abovementioned features and the features still to be explained below of the subject matter of the invention can be used not only in the particular combination indicated but also in any other combinations without going outside the scope of the invention.

Static charges can occur on electric insulators or articles or persons insulated by such insulators and are frequently undesirable, damaging and sometimes dangerous. For example, it may be necessary to work in a dust-reduced atmosphere in some medical applications or in the production of electronic components. However, electrostatic charging of persons or articles leads to dust particles adhering to an increased extent on these persons or articles, and these dust particles can in these cases then lead to complications. Furthermore, electrostatic charges can lead to sudden discharges as a result of which, for example, electronic components can be damaged. In places where a risk of explosion is present, electrostatic discharges can even cause explosions. Attempts are therefore made to reduce the risk of electrostatic charging by earthing these articles or persons.

In many cases, the electric insulators are polymers. Since these polymers can usually not be replaced by conductive materials, attempts are made to increase the conductivity of the polymers by addition of antistatic additives and to earth the articles or materials concerned. Polymers comprising antistatic additives will hereinafter be referred to as antistatic polymers.

Such antistatic polymers are known. For example, DE 3531660 describes antistatic polyurethane shoe soles. The antistatic effect is achieved by means of 0.01 to 0.3% by weight of chemically bound sulfonate groups. The volume resistances achieved are <10⁸ Ω/cm.

Furthermore, EP 270 009 describes antistatic polyurethane shoe soles in which sodium triphenylborate is present as antistatic additive.

The use of various quaternary ammonium salts for increasing the conductivity of polymers is described in EP 1134268. These are modifications of commercial antistatics such as Catafor F® or Catafor PU® from Rhodia. Volume resistances of about 10⁷ Ω/cm are achieved in this way. The examples in EP 1134268 demonstrate a significant dependence of the volume resistance on the atmospheric humidity.

DE 3528597 describes the use of carbon blacks as conductivity improvers. Volume resistances of <10⁹ Ω/cm are achieved. Disadvantages here are the black color of the product and reduced mechanical properties when relatively large amounts are used.

A disadvantage of the prior art is the sometimes still very high volume resistance of such a polymer of 10⁷ Ω/cm or more and the dependence of the volume resistances on the atmospheric humidity. As a result, static charges can occur despite conductive additives.

A further disadvantage of the antistatic additives proposed in the prior art is their sometimes unsatisfactory long-term action, as a result of which the volume resistance of the polymers increases in particular cases after only a few days.

Finally, large additions of known antistatic additives lead to a deterioration in the materials properties.

It was therefore an object of the invention to provide antistatic polyurethanes which have a volume resistance of less than 10⁷ Ω/cm and do not have the abovementioned disadvantages.

This object is achieved by polyurethanes which comprise an ionic liquid.

For the purposes of the present invention, ionic liquids are (A) preferably salts of the general formula (I)

[A]ₙ⁺[Y]ⁿ⁻ (I),

where n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion;

(B) mixed salts of the general formulae (II)

[A¹]⁺[A²]⁺[Y]ⁿ⁻ (IIa), where n=2;

[A¹]⁺[A²]⁺[A³]⁺[Y]ⁿ⁻ (IIb), where n=3; or

[A¹]⁺[A²]⁺[A³]⁺[A⁴]⁺[Y]ⁿ⁻ (IIc), where n=4;

where [A¹]⁺, [A²]⁺, [A³]⁺ and [A⁴]⁺ are selected independently from among the groups mentioned for [A]⁺ and [Y]ⁿ⁻ is as defined under (A); or

(C) mixed salts of the general formulae (III)

[A¹]⁺[A²]⁺[A³]⁺[M¹]⁺[Y]ⁿ⁻ (IIIa), where n=4;

[A¹]⁺[A²]⁺[M¹]⁺[M²]⁺[Y]ⁿ⁻ (IIIb), where n=4;

[A¹]⁺[M¹]⁺[M²]⁺[M³]⁺[Y]ⁿ⁻ (IIIc), where n=4;

[A¹]⁺[A²]⁺[M¹]⁺[Y]ⁿ⁻ (IIId), where n=3;

[A¹]⁺[M¹]⁺[M²]⁺[Y]ⁿ⁻ (IIIe), where n=3;

[A¹]⁺[M¹]⁺[Y]ⁿ⁻ (IIIf), where n=2;

[A¹]⁺[A²]⁺[M⁴]²⁺[Y]ⁿ⁻ (IIIg), where n=4;

[A¹]⁺[M¹]⁺[M⁴]²⁺[Y]ⁿ⁻ (IIIh), where n=4;

[A¹]⁺[M⁵]³⁺[Y]ⁿ⁻ (IIIi), where n=4; or

[A¹]⁺[M⁴]²⁺[Y]ⁿ⁻ (IIIj), where n=3;

where [A¹]⁺, [A²]⁺ and [A³]⁺ are selected independently from among the groups mentioned for [A]⁺, [Y]ⁿ⁻ is as defined under (A) and [M¹]⁺, [M²]⁺, [M³]⁺ are monovalent metal cations, [M⁴]²⁺ are divalent metal cations and [M⁵]³⁺ are trivalent metal cations.

The ionic liquids have a melting point of in the range from −50° C. to 150° C., more preferably in the range from −20° C. to below 100° C. and even more preferably from −20° C. to below 80° C. The melting point of the ionic liquid is preferably below 50° C.; in particular, ionic liquids used according to the invention are liquid at room temperature. Ionic liquids which are liquid at room temperature are readily processable and have an excellent antistatic action.

Compounds which are suitable for forming the cation [A]⁺ of ionic liquids are, for example, known from DE 102 02 838 A1. Thus, such compounds can comprise oxygen, phosphorus, sulfur or in particular nitrogen atoms, for example at least one nitrogen atom, preferably 1-10 nitrogen atoms, particularly preferably 1-5 nitrogen atoms, very particularly preferably 1-3 nitrogen atoms and in particular 1-2 nitrogen atoms. If appropriate, further heteroatoms such as oxygen, sulfur or phosphorus atoms can also be present. The nitrogen atom is a suitable carrier of the positive charge in the cation of the ionic liquid, from which a proton or an alkyl radical can then be transferred in equilibrium to the anion so as to produce an electrically neutral molecule.

If the nitrogen atom is the carrier of the positive charge in the cation of the ionic liquid, a cation can firstly be produced by quaternization of the nitrogen atom of, for example, an amine or a nitrogen heterocycle in the synthesis of the ionic liquids. Quaternization can be effected by alkylation of the nitrogen atom. Depending on the alkylation reagent used, salts having different anions are obtained. In cases in which it is not possible to form the desired anion directly in the quaternization, it is introduced in a further step of the synthesis. For example, starting from an ammonium halide, the halide can be reacted with a Lewis acid to form a complex anion from the halide and Lewis acid. As an alternative, it is possible to replace a halide ion by the desired anion. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000, 112, pp. 3926-3945, and the references cited therein.

Suitable alkyl radicals by which the nitrogen atom in the amines or nitrogen heterocycles can be quaternized, for example, are C₁-C₁₈-alkyl, preferably C₁-C₁₀-alkyl, particularly preferably C₁-C₆-alkyl and very particularly preferably methyl. The alkyl group can be unsubstituted or have one or more identical or different substituents.

Preference is given to using compounds which comprise at least one five- or six-membered heterocycle, in particular a five-membered heterocycle, which has at least one nitrogen atom and, if appropriate, an oxygen or sulfur atom as cations; particular preference is given to compounds which comprise at least one five- or six-membered heterocycle which has one, two or three nitrogen atoms and a sulfur or oxygen atom, very particularly preferably those having two nitrogen atoms. Further preference is given to aromatic heterocycles such as pyridinium, pyridazinium, pyrimidinium, pyrazinium, imidazolium, pyrazolium, pyrazolinium, imidazolium, thiazolium, oxazolium, pyrrolidinium and imidazolidinium.

Among these compounds, preference is given to cations which have a molecular weight of less than 1000 g/mol, very particularly preferably less than 500 g/mol and in particular less than 250 g/mol.

Furthermore, preference is given to cations selected from among the compounds of the formulae (IVa) to (IVw),

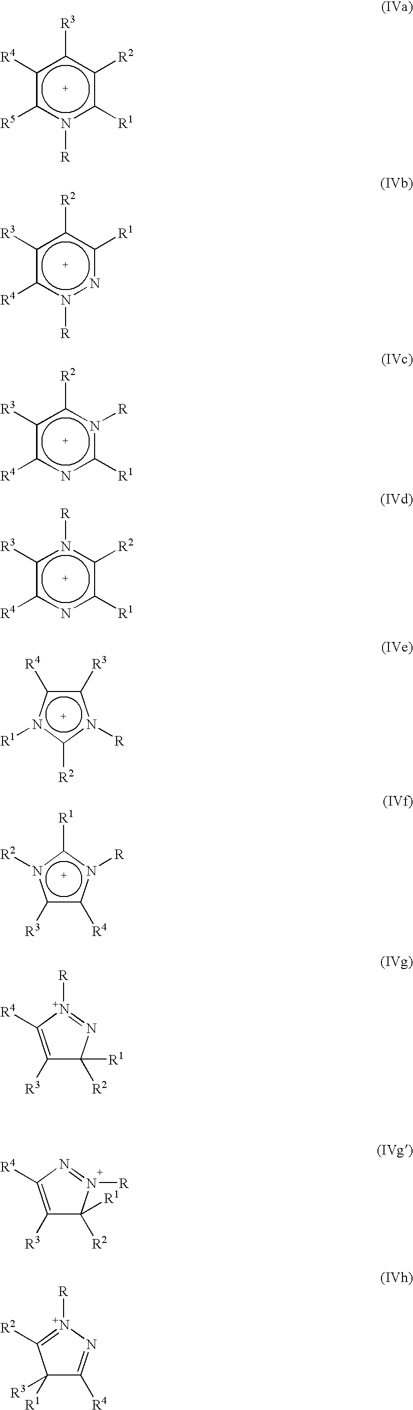

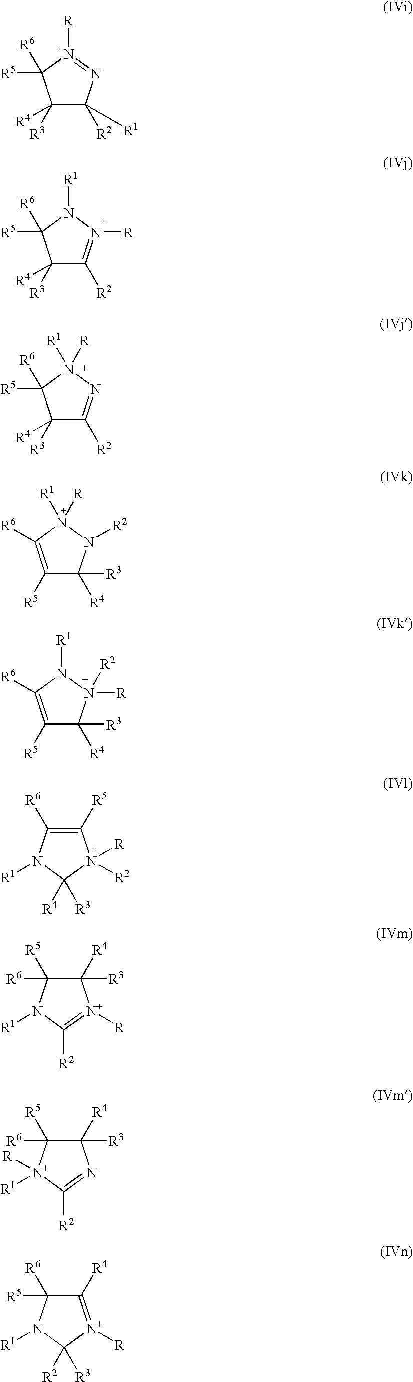

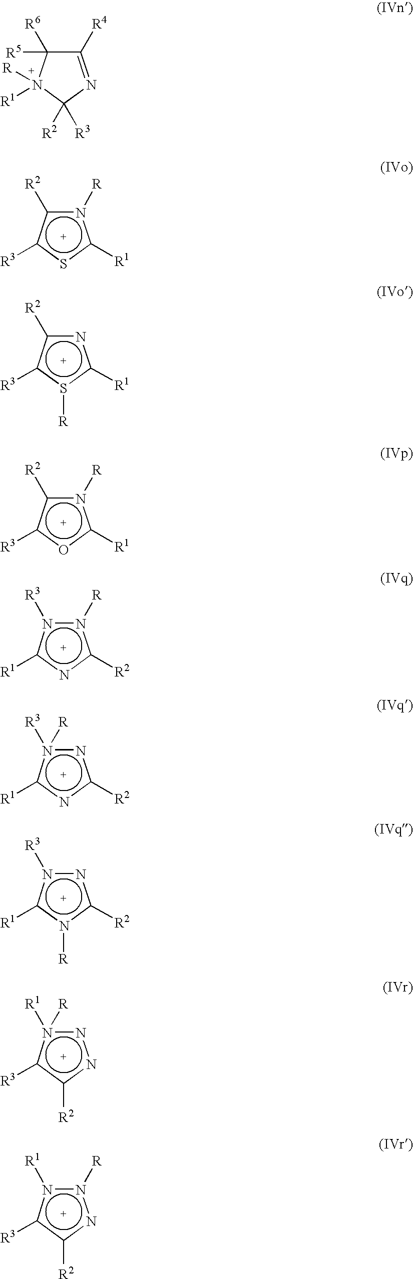

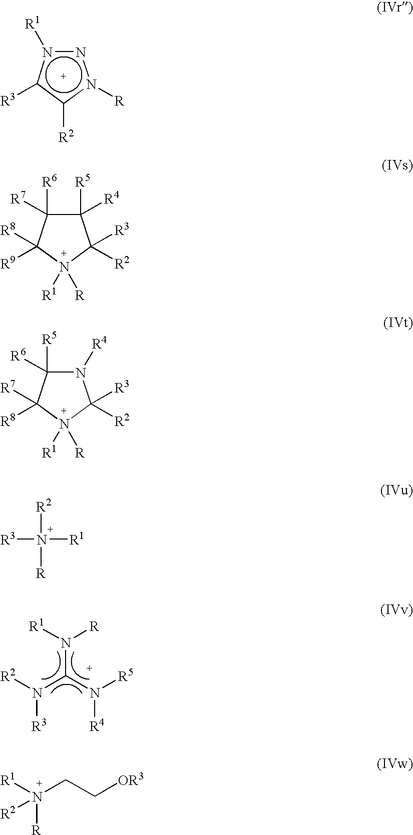

and oligomers comprising these structures.

Further suitable cations are compounds of the general formulae (IVx) and (IVy)

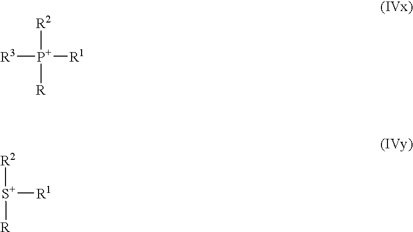

and oligomers comprising these structures.

In the above formulae (IVa) to (IVy),
the radical R is hydrogen, a carbon-comprising organic, saturated or unsaturated, acyclic or cyclic, aliphatic, aromatic or araliphatic radical which has from 1 to 20 carbon atoms and may be unsubstituted or interrupted or substituted by from 1 to 5 heteroatoms or functional groups; and
the radicals R¹ to R⁹ are each, independently of one another, hydrogen, a sulfo group or an organic, saturated or unsaturated, acyclic or cyclic, aliphatic, aromatic or araliphatic radical which has from 1 to 20 carbon atoms and may be unsubstituted or interrupted or substituted by from 1 to 5 heteroatoms or functional groups, where the radicals R¹ to R⁹ which are bound to a carbon atom (and not to a heteroatom) in the abovementioned formulae (IV) may also be halogen or a functional group; or

two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or interrupted or substituted by from 1 to 5 heteroatoms or functional groups.

In the definition of the radicals R and R¹ to R⁹, heteroatoms can in principle be all heteroatoms which are able to formally replace a —CH₂—, —CH═, —C≡ or ═C═ group. If the carbon-comprising radical comprises heteroatoms, preference is given to oxygen, nitrogen, sulfur, phosphorus and silicon. As preferred groups, particular mention may be made of —O—, —S—, —SO—, —SO₂—, —NR′—, —N═, —PR′—, —PR′₂ and —SiR′₂—, where the radicals R′ are in each case the remaining part of the carbon-comprising radical. The radicals R¹ to R⁹ can, in the cases where they are bound to a carbon atom (and not to a heteroatom) in the abovementioned formulae (IV), also be bound directly via the heteroatom.

Suitable functional groups are in principle all functional groups which can be bound to a carbon atom or a heteroatom. Examples which may be mentioned are —OH (hydroxy), ═O (in particular as a carbonyl group), —NH₂ (amino), ═NH (imino), —COOH (carboxy), —CONH₂ (carboxamide), —SO₃H (sulfo) and —CN (cyano). Functional groups and heteroatoms can also be directly adjacent, so that combinations of a plurality of adjacent atoms such as —O— (ether), —S— (thioether), —COO— (ester), —CONH— (secondary amide) or —CONR′— (tertiary amide) are also encompassed, for example di(C₁-C₄-alkyl)amino, C₁-C₄-alkyloxycarbonyl or C₁-C₄-alkyloxy.

As halogens, mention may be made of fluorine, chlorine, bromine and iodine.

The radical R is preferably
unbranched or branched C₁-C₁₈-alkyl which may be unsubstituted or substituted by one or more hydroxy, halogen, phenyl, cyano, C₁-C₆-alkoxycarbonyl and/or sulfonic acid groups and has a total of from 1 to 20 carbon atoms, for example methyl, ethyl, 1-propyl, 2-propyl, 1-butyl, 2-butyl, 2-methyl-1-propyl(isobutyl), 2-methyl-2-propyl(tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
a radical which is derived from glycols, butylene glycols and their oligomers having from 1 to 100 units and a hydrogen or a C₁-C₈-alkyl group as end group, for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O—, where R^{A} and R^{B} are preferably hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl;
vinyl; and
N,N-di-C₁-C₆-alkylamino such as N,N-dimethylamino and N,N-diethylamino.

The radical R is particularly preferably unbranched and unsubstituted C₁-C₁₈-alkyl such as methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl, or CH₃O—(CH₂CH₂O)ₙ—CH₂CH₂— and CH₃CH₂O—(CH₂CH₂O)ₙ—CH₂CH₂—, where n is from 0 to 3.

Preference is given to the radicals R¹ to R⁹ each being, independently of one another,
hydrogen;
halogen;
a functional group, in particular one as mentioned above;
C₁-C₁₈-alkyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₂-C₁₈-alkenyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₆-C₁₂-aryl which may optionally be substituted by functional groups, aryl, alkyl, aryloxy, alkyloxy, halogen, heteroatoms and/or heterocycles;
C₅-C₁₂-cycloalkyl which may optionally be substituted by functional groups, aryl, alkyl, aryloxy, alkyloxy, halogen, heteroatoms and/or heterocycles;
C₅-C₁₂-cycloalkenyl which may optionally be substituted by functional groups, aryl, alkyl, aryloxy, alkyloxy, halogen, heteroatoms and/or heterocycles; or
a five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles; or

two adjacent radicals together form
an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups.

C₁-C₁₈-Alkyl which may optionally be substituted by functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl(isobutyl), 2-methyl-2-propyl(tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl(phenylmethyl), diphenylmethyl(benzhydryl), triphenylmethyl, 1-phenylethyl, 2-phenylethyl, 3-phenylpropyl, α,α-dimethylbenzyl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, acetyl, CₙF_{2(n-a)+(1-b)}H_{2a+b} where n is from 1 to 30, 0≦a≦n and b=0 or 1 (for example CF₃, C₂F₅, CH₂CH₂—C₍ₙ₋₂₎F₂₍ₙ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)ethyl, 2-(ethoxycarbonyl)ethyl, 2-(n-butoxycarbonyl)ethyl, butylthiomethyl, 2-dodecylthioethyl, 2-phenylthioethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl,11-ethoxy-4,8-dioxaundecyl, 15-ethoxy-4,8,12-trioxapentadecyl, 9-ethoxy-5-oxanonyl or 14-ethoxy-5,10-oxatetradecyl.

C₂-C₁₈-Alkenyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups is preferably vinyl, 2-propenyl, 3-butenyl, cis-2-butenyl, trans-2-butenyl or CₙF_{2(n-a)-(1-b)}H_{2a-b} where n≦30, 0≦a≦n and b=0 or 1.

C₆-C₁₂-Aryl which may optionally be substituted by functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5.

C₅-C₁₂-Cycloalkyl which may optionally be substituted by functional groups, aryl, alkyl, aryloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₙF_{2(n-a)-(1-b)}H_{2a-b} where n—30, 0≦a≦n and b=0 or 1 or a saturated or unsaturated bicyclic system such as norbornyl or norbornenyl.

C₅-C₁₂-Cycloalkenyl which may optionally be substituted by functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF_{2(n-a)-3(1-b)}H_{2a-3b} where n≦30, 0≦a≦n and b=0 or 1.

A five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles is preferably furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl or difluoropyridyl.

If two adjacent radicals together form an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, the two groups together are preferably 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the abovementioned radicals comprise oxygen and/or sulfur atoms and/or substituted or unsubstituted imino groups, then the number of oxygen and/or sulfur atoms and/or imino groups is not subject to any restrictions. In general, there will be no more than 5 in the radical, preferably no more than 4 and very particularly preferably no more than 3.

If the abovementioned radicals comprise heteroatoms, then there is generally at least one carbon atom, preferably at least two carbon atoms, between any two heteroatoms.

Particular preference is given to the radicals R¹ to R⁹ each being, independently of one another,
hydrogen;
unbranched or branched C₁-C₁₈-alkyl which may be unsubstituted or substituted by one or more hydroxy, halogen, phenyl, cyano, C₁-C₆-alkoxycarbonyl and/or sulfonic acid groups and has a total of from 1 to 20 carbon atoms, for example methyl, ethyl, 1-propyl, 2-propyl, 1-butyl, 2-butyl, 2-methyl-1-propyl(isobutyl), 2-methyl-2-propyl(tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
glycols, butylene glycols and oligomers thereof having from 1 to 100 units and a hydrogen or a C₁-C₈-alkyl group as end group, for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O, where R^{A} and R^{B} are each preferably hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl;
vinyl; and
N,N-di-C₁-C₆-alkylamino such as N,N-dimethylamino and N,N-diethylamino.

Very particular preference is given to the radicals R¹ to R⁹ each being, independently of one another, hydrogen or C₁-C₁₈-alkyl such as methyl, ethyl, 1-butyl, 1-pentyl, 1-hexyl, 1-heptyl, 1-octyl, phenyl, 2-hydroxyethyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₙ—CH₂CH₂— and CH₃CH₂O—(CH₂CH₂O)ₙ—CH₂CH₂— where n is from 0 to 3.

Very particularly preferred pyridinium ions (IVa) are those in which
one of the radicals R¹ to R⁵ is methyl, ethyl or chlorine and the remaining radicals R¹ to R⁵ are hydrogen;
R³ is dimethylamino and the remaining radicals R¹, R², R⁴ and R⁵ are hydrogen;
all radicals R¹ to R⁵ are hydrogen;
R² is carboxy or carboxamide and the remaining radicals R¹, R², R⁴ and R⁵ are hydrogen; or
R¹ and R² or R² and R³ are together 1,4-buta-1,3-dienylene and the remaining radicals R¹, R², R⁴ and R⁵ are hydrogen;

and in particular those in which
R¹ to R⁵ are each hydrogen; or
one of the radicals R¹ to R⁵ is methyl or ethyl and the remaining radicals R¹ to R⁵ are hydrogen.

As very particularly preferred pyridinium ions (IVa), mention may be made of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethylpyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium.

Very particularly preferred pyridazinium ions (IVb) are those in which
R¹ to R⁴ are each hydrogen; or
one of the radicals R¹ to R⁴ is methyl or ethyl and the remaining radicals R¹ to R⁴ are hydrogen.

Very particularly preferred pyrimidinium ions (IVc) are those in which
R¹ is hydrogen, methyl or ethyl and R² to R⁴ are each, independently of one another, hydrogen or methyl; or
R¹ is hydrogen, methyl or ethyl, R² and R⁴ are each methyl and R³ is hydrogen.

Very particularly preferred pyrazinium ions (IVd) are those in which
R¹ is hydrogen, methyl or ethyl and R² to R⁴ are each, independently of one another, hydrogen or methyl;
R¹ is hydrogen, methyl or ethyl, R² and R⁴ are each methyl and R³ is hydrogen;
R¹ to R⁴ are each methyl; or
R¹ to R⁴ are each methyl or hydrogen.

Very particularly preferred imidazolium ions (IVe) are those in which
R¹ is hydrogen, methyl, ethyl, 1-propyl, 1-butyl, 1-pentyl, 1-hexyl, 1-octyl, 2-hydroxyethyl or 2-cyanoethyl and R² to R⁴ are each, independently of one another, hydrogen, methyl or ethyl.

As very particularly preferred imidazolium ions (IVe), mention may be made of 1-methylimidazolium, 1-ethylimidazolium, 1-(1-butyl)imidazolium, 1-(1-octyl)-imidazolium, 1-(1-dodecyl)imidazolium, 1-(1-tetradecyl)imidazolium, 1-(1-hexadecyl)-imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethyl-imidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethyl-imidazolium, 1,4,5-trimethyl-3-butylimidazolium and 1,4,5-trimethyl-3-octylimidazolium.

Very particularly preferred pyrazolium ions (IVf), (IVg) and (IVg′) are those in which
R¹ is hydrogen, methyl or ethyl and R² to R⁴ are each, independently of one another, hydrogen or methyl.

Very particularly preferred pyrazolium ions (IVh) are those in which
R¹ to R⁴ are each, independently of one another, hydrogen or methyl.

Very particularly preferred 1-pyrazolinium ions (IVi) are those in which
R¹ to R⁶ are each, independently of one another, hydrogen or methyl.

Very particularly preferred 2-pyrazolinium ions (IVj) and (IVj′) are those in which
R¹ is hydrogen, methyl, ethyl or phenyl and R² to R⁶ are each, independently of one another, hydrogen or methyl.

Very particularly preferred 3-pyrazolinium ions (IVk) and (IVk′) are those in which
R¹ and R² are each, independently of one another, hydrogen, methyl, ethyl or phenyl and R³ to R⁶ are each, independently of one another, hydrogen or methyl.

Very particularly preferred imidazolinium ions (IVl) are those in which
R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IVm) and (IVm′) are those in which
R¹ and R² are each, independently of one another, hydrogen, methyl or ethyl and R³ to R⁶ are each, independently of one another, hydrogen or methyl.

Very particularly preferred imidazolinium ions (IVn) and (IVn′) are those in which
R¹ to R³ are each, independently of one another, hydrogen, methyl or ethyl and R⁴ to R⁶ are each, independently of one another, hydrogen or methyl.

Very particularly preferred thiazolium ions (IVo) and (IVo′) and oxazolium ions (IVp) are those in which
R¹ is hydrogen, methyl, ethyl or phenyl and R² and R³ are each, independently of one another, hydrogen or methyl.

Very particularly preferred 1,2,4-triazolium ions (IVq), (IVq′) and (IVq″) are those in which
R¹ and R² are each, independently of one another, hydrogen, methyl, ethyl or phenyl and R³ is hydrogen, methyl or phenyl.

Very particularly preferred 1,2,3-triazolium ions (IVr), (IVr′) and (IVr″) are those in which
R¹ is hydrogen, methyl or ethyl and R² and R³ are each, independently of one another, hydrogen or methyl or R² and R³ are together 1,4-buta-1,3-dienylene.

Very particularly preferred pyrrolidinium ions (IVs) are those in which
R¹ is hydrogen, methyl, ethyl or phenyl and R² to R⁹ are each, independently of one another, hydrogen or methyl.

Very particularly preferred imidazolidinium ions (IVt) are those in which
R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IVu) are those in which
R¹ to R³ are each, independently of one another, C₁-C₁₈-alkyl; or
R¹ and R² are together 1,5-pentylene or 3-oxa-1,5-pentylene and R³ is C₁-C₁₈-alkyl, 2-hydroxyethyl or 2-cyanoethyl.

As very particularly preferred ammonium ions (IVu), mention may be made of methyltri(1-butyl)ammonium, N,N-dimethylpiperidinium and N,N-dimethylmorpholinium.

Examples of tertiary amines from which the quaternary ammonium ions of the general formula (IVu) are derived by quaternization by the abovementioned radicals R are diethyl-n-butylamine, diethyl-tert-butylamine, diethyl-n-pentylamine, diethylhexylamine, diethyloctylamine, diethyl(2-ethylhexyl)amine, di-n-propylbutylamine, di-n-propyl-n-pentylamine, di-n-propylhexylamine, di-n-propyloctylamine, di-n-propyl(2-ethylhexyl)amine, diisopropylethylamine, diisopropyl-n-propylamine, diisopropylbutylamine, diisopropylpentylamine, diisopropylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl(2-ethylhexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propylphenylamine and di-n-butylphenylamine.

Preferred tertiary amines (IVu) are diisopropylethylamine, diethyl-tert-butylamine, diisopropylbutylamine, di-n-butyl-n-pentylamine, N,N-di-n-butylcyclohexylamine and tertiary amines derived from pentyl isomers.

Particularly preferred tertiary amines are di-n-butyl-n-pentylamine and tertiary amines derived from pentyl isomers. A further preferred tertiary amine which has three identical radicals is triallylamine.

Very particularly preferred guanidinium ions (IVv) are those in which
R¹ to R⁵ are each methyl.

As a very particularly preferred guanidinium ion (IVv), mention may be made of N,N,N′,N′,N″,N″-hexamethylguanidinium.

Very particularly preferred cholinium ions (IVw) are those in which
R¹ and R² are each, independently of one another, methyl, ethyl, 1-butyl or 1-octyl and R³ is hydrogen, methyl, ethyl, acetyl, —SO₂OH or —PO(OH)₂;
R¹ is methyl, ethyl, 1-butyl or 1-octyl, R² is a —CH₂—CH₂—OR⁴ group and R³ and R⁴ are each, independently of one another, hydrogen, methyl, ethyl, acetyl, —SO₂OH or —PO(OH)₂; or
R¹ is a —CH₂—CH₂—OR⁴ group, R² is a —CH₂—CH₂—OR⁵ group and R³ to R⁵ are each independently of one another, hydrogen, methyl, ethyl, acetyl, —SO₂OH or —PO(OH)₂.

Particularly preferred cholinium ions (IVw) are those in which R³ is selected from among hydrogen, methyl, ethyl, acetyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

Very particularly preferred phosphonium ions (IVx) are those in which
R¹ to R³ are each, independently of one another, C₁-C₁₈-alkyl, in particular butyl, isobutyl, 1-hexyl or 1-octyl.

Among the abovementioned heterocyclic cations, the pyridinium ions, pyrazolinium ions, pyrazolium ions and the imidazolinium and the imidazolium ions are preferred. Furthermore, ammonium ions are preferred.

Particular preference is given to 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium and 1,4,5-trimethyl-3-octylimidazolium.

The metal cations [M¹]⁺, [M²]⁺, [M³]⁺, [M⁴]²⁺ and [M⁵]³⁺ in the formulae (IIIa) to (IIIj) are generally metal cations of groups 1, 2, 6, 7, 8, 9, 10, 11, 12 and 13 of the Periodic Table. Suitable metal cations are, for example, Li⁺, Na⁺, K⁺, Cs⁺, Mg²⁺, Ca²⁺, Ba²⁺, Cr³⁺, Fe²⁺, Fe³⁺, Co²⁺, Ni²⁺, Cu²⁺, Ag⁺, Zn²⁺ and Al³⁺.

As anions, it is in principle possible to use all anions.

The anion [Y]ⁿ⁻ of the ionic liquid is, for example, selected from among
the group of halides and halogen-comprising compounds of the formulae:
   F⁻, Cl⁻, Br⁻, I⁻, BF₄⁻, PF₆⁻, AlCl₄⁻, Al₂Cl₇⁻, Al₃Cl₁₀⁻, AlBr₄⁻, FeCl₄⁻, BCl₄⁻, SbF₆⁻, AsF₆⁻, ZnCl₃⁻, SnCl₃⁻, CuCl₂⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:
SO₄²⁻, HSO₄⁻, SO₃²⁻, HSO₃⁻, R^{a}SO₃⁻, R^{a}SO₃⁻
the group of phosphates of the general formulae:
   PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
R^{a}HPO₃⁻, R^{a}R^{b}PO₂⁻, R^{a}R^{b}PO₃⁻
the group of phosphites of the general formulae:
   PO₃³⁻, HPO₃²⁻, H₂PO₃⁻, R^{a}PO₃²⁻, R^{a}HPO₃⁻, R^{a}R^{b}PO₃⁻
the group of phosphonites and phosphinites of the general formulae:
   R^{a}R^{b}PO₂⁻, R^{a}HPO₂⁻, R^{a}R^{b}PO⁻, R^{a}HPO⁻
the group of carboxylic acids of the general formula:
   R^{a}COO⁻
the group of borates of the general formulae:
   BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:
   R^{a}BO₂²⁻, R^{a}R^{b}BO⁻
the group of carbonates and carbonic esters of the general formulae:
   HCO₃⁻, CO₃²⁻, R^{a}CO₃⁻
the group of silicates and silicic esters of the general formulae:
   SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:
   R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae:

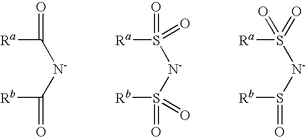

the group of methides of the general formula:

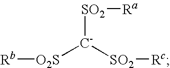

the group of alkoxides and aryloxides of the general formula:
   R^{a}O⁻;
the group of halometalates of the general formula
   [M_{q}Halᵣ]^{s-},
   where M is a metal and Hal is fluorine, chlorine, bromine or iodine, q and r are positive integers and indicate the stoichiometry of the complex and s is a positive integer and indicates the charge on the complex;
the group of sulfides, hydrogensulfides, polysulfides, hydrogenpolysulfides and thiolates of the general formulae:
   S²⁻, HS⁻, [Sᵥ]²⁻, [HSᵥ]⁻, [R^{a}S]⁻,
   where v is a positive integer from 2 to 10;
the group of complex metal ions such as Fe(CN)₆³⁻, Fe(CN)₆⁴⁻, MnO₄⁻, Fe(CO)₄⁻.

Here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- to six-membered, oxygen-, nitrogen- and/or sulfur-comprising heterocycle, where two of them may together form an unsaturated, saturated or aromatic ring which may optionally be interrupted by one or more oxygen and/or sulfur atoms and/or one or more substituted or unsubstituted imino groups, where the radicals mentioned may each be additionally substituted by functional groups, aryl, alkyl, aryloxy, alkyloxy, halogen, heteroatoms and/or heterocycles.

Here, C₁-C₁₈-alkyl which may optionally be substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl,1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-Alkyl which may optionally be interrupted by one or more nonadjacent oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, they can together form as fused-on building block, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is in principle not subject to any restrictions or is automatically restricted by the size of the radical or the cyclic building block. In general, there will be no more than 5 in the respective radical, preferably no more than 4 and very particularly preferably no more than 3. Furthermore, there is generally at least one, preferably at least two, carbon atom(s) between any two heteroatoms.

Substituted and unsubstituted imino groups can be, for example, imino, methylimino, isopropylimino, n-butylimino or tert-butylimino.

For the purposes of the present invention, the term “functional groups” refers, for example, to the following: carboxy, carboxamide, hydroxy, di(C₁-C₄-alkyl)amino, C₁-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-Aryl which may optionally be substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-Cycloalkyl which may optionally be substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-comprising heterocycle is, for example, furyl, thiophenyl, pyrryl, pyridyl, indolyl, benzoxazolyl, dioxolyl, dioxyl, benzimidazolyl, benzothiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

As ionic liquid for the purposes of the invention, preference is given to using substances having a soft cation and/or a soft anion. This means that cations and/or anions are well-stabilized, for example by inductive and/or mesomeric effects. Cations preferably have electron-pushing substituents. The cation preferably comprises exclusively electron-pushing substituents. The anion preferably has electron-pulling substituents. Particular preference is given to using an ionic liquid in which the charge on the cation, on the anion or on the cation and the anion is delocalized by mesomeric effects. Imidazolium, guanidinium or pyrazolium derivatives are therefore preferred as cations. The ionic liquids used according to the invention particularly preferably have cations selected from the group consisting of 1,2,3-trimethylimidazolium, 1,3,4,5-tetramethylimidazolium, 1,3,4-dimethylimidazolium, 1,3,4-trimethylimidazolium, 1,3-dibutyl-2-methylimidazolium, 1,3-dibutylimidazolium, 1,2-dimethylimidazolium, 1,3-dimethylimidazolium, 1-benzyl-3-methylimidazolium, 1-butyl-2,3-dimethylimidazolium, 1-butyl-2-ethyl-5-methylimidazolium, 1-butyl-2-ethylimidazolium, 1-butyl-2-methylimidazolium, 1-butyl-3,4,5-trimethylimidazolium, 1-butyl-3,4-dimethylimidazolium, 1-butyl-3-ethylimidazolium, 1-butyl-3-methylimidazolium, 1-butyl-4-methylimidazolium, 1-butylimidazolium, 1-decyl-3-methylimidazolium, 1-dodecyl-3-methylimidazolium, 1-ethyl-2,3-dimethylimidazolium, 1-ethyl-3-methylimidazolium, 1-hexadecyl-2,3-dimethylimidazolium, 1-hexadecyl-3-methylimidazolium, 1-hexyl-2,3-dimethylimidazolium, 1-hexyl-3-methylimidazolium, 1-methyl-2-ethylimidazolium, 1-methyl-3-octylimidazolium, 1-methylimidazolium, 1-pentyl-3-methylimidazolium, 1-phenylpropyl-3-methylimidazolium, 1-propyl-2,3-dimethylimidazolium, 1-tetradecyl-3-methylimidazolium, 2,3-dimethylimidazolium, 2-ethyl-3,4-dimethylimidazolium, 3,4-dimethylimidazolium, 1,2-dimethylpyridinium, guanidinium, hexamethylguanidinium, N,N,N′,N′-tetramethyl-N″-ethylguanidinium, N-pentamethyl-N-isopropylguanidinium, N-pentamethyl-N-propylguanidinium, benzyltriphenylphosphonium, tetrabutylphosphonium, trihexyl(tetradecyl)phosphonium and triisobutyl(methyl)phosphonium.

Even more strongly preferred cations are selected from the group consisting of 1,2,3-trimethylimidazolium, 1,2-dimethylimidazolium, 1-butyl-2-methylimidazolium, 1-butyl-4-methylimidazolium, 1,3-diethylimidazolium, 1-benzyl-3-methylimidazolium, 1-butyl-2,3-dimethylimidazolium, 1-butyl-2-methylimidazolium, 1-butyl-3-ethylimidazolium, 1-butyl-3-methylimidazolium, 1-butylimidazolium, 1-ethyl-2,3-dimethylimidazolium, 1-ethyl-3-methylimidazolium, 1-hexyl-3-methylimidazolium, 1-methyl-2-ethylimidazolium, 1-methyl-3-octylimidazolium, 1-methylimidazolium, 1-decyl-3-methylimidazolium, 1-dodecyl-3-methylimidazolium, guanidinium, N,N,N′,N′-tetramethyl-N″-ethylguanidinium, benzyltriphenylphosphonium and tetrabutylphosphonium.

In particular, the cations are selected from the group consisting of 1,2,3-trimethylimidazolium, 1,2-dimethylimidazolium, 1-butyl-2,3-dimethylimidazolium, 1-butyl-3-methylimidazolium, 1-ethyl-2,3-dimethylimidazolium, 1-ethyl-3-methyl-imidazolium, 1-butylimidazolium and 1-methylimidazolium.

For the process of the invention, the anions are preferably selected from the group consisting of acetate, bis(2,4,4-trimethylpentyl)phosphinate, bis(malonato)borate, bis(oxalato)borate, bis(pentafluoroethyl)phosphinate, bis(phthalato)borate, bis(salicylato)borate, bis(trifluoromethanesulfonyl)imidate, bis(trifluoromethyl)imidate, borate, bromide, bromoaluminates, carbonate, chloroaluminates, decylbenzenesulfonate, dichlorocuprate, dicyanamide, didecylbenzenesulfonate, didodecylbenzenesulfonate, diethylphosphate, dihydrogenphosphate, dodecylbenzenesulfonate, ethylsulfate, ethylsulfonate, fluoride, hexafluorophosphate, hydrogencarbonate, hydrogenphosphate, hydrogensulfate, hydrogensulfite, iodide, methylsulfate, methylsulfonate, nitrate, nitrite, phosphate, sulfite, tetracyanoborate, tetrafluoroborate, tetrakis(hydrogensulfato)borate, tetrakis(methylsulfonato)borate, thiocyanate, tosylate, trichlorozincate, trifluoroacetate, trifluoromethylsulfonate, tris(heptafluoropropyl)trifluorophosphate, tris(nonafluorobutyl)trifluorophosphate, tris(pentafluoroethyl)trifluorophosphate, tris(pentafluoroethylsulfonyl)trifluorophosphate.

Particularly preferred anions are hexafluorophosphate, tetrafluoroborate, thiocyanate and dicyanamide, ethylsulfate, diethylphosphate, methylsulfate, bromide, iodide, p-toluenesulfonate and methanesulfonate.

In particular, for the purposes of the invention, the ionic liquids used are 1-ethyl-3-methylimidazolium methylsulfonate, 1-ethyl-3-methylimidazolium dicyanamide, 1-ethyl-3-methylimidazolium ethylsulfate, 1-ethyl-3-methylimidazolium thiocyanate, 1-ethyl-3-methylimidazolium tetrafluoroborate and 1-ethyl-3-methylimidazolium hexafluorophosphate, 1-ethyl-3-methylimidazolium diethylphosphate, 1-ethyl-3-methylimidazolium bromide, 1-ethyl-3-methylimidazolium p-toluenesulfonate and also 1-butyl-3-methylimidazolium methanesulfonate, 1-butyl-3-methylimidazolium dicyanamide, 1-butyl-3-methylimidazolium ethylsulfate, 1-butyl-3-methylimidazolium thiocyanate, 1-butyl-3-methylimidazolium dimethylphosphate, 1-butyl-3-methylimidazolium bromide, 1-butyl-3-methylimidazolium p-toluenesulfonate, 1-butyl-3-methylimidazolium tetrafluoroborate and 1-butyl-3-methylimidazolium hexafluorophosphate.

For use as antistatic additive according to the invention, this ionic liquid can be used either alone or together with further antistatic additives. Mention may here be made of, for example, combinations of ionic liquids with one another or of ionic liquids with other known antistatic additives such as Catafor F® or Catafor PU® from Rhodia.

The antistatic additive is preferably comprised in the antistatic polyurethane in an amount of from 0.001 to 30 percent by weight, particularly preferably from 0.01 to 20 percent by weight, very particularly preferably from 0.1 to 10 percent by weight and in particular from 0.1 to 7 percent by weight, based on the total weight of the polyurethane. The volume resistance of the antistatic polyurethane increases greatly as a result, especially on addition of the ionic liquid in an amount of up to 10 percent by weight. The total weight of the antistatic polymer is made up of the weight of the polymer chains plus any catalysts, fillers and additives comprised. The ionic liquid is preferably not covalently bound to the polymer chain of the antistatic polymer.

As polyurethanes comprising an ionic liquid, it is possible to use all known polyisocyanate polyaddition products. These comprise, in particular, thermoplastic polyurethanes and elastomeric polyurethanes and also foams based on these polyurethanes. For the purposes of the invention, polyurethanes include polymer blends comprising polyurethanes and further polymers and also foams comprising these polymer blends. The ionic liquids are particularly preferably comprised in a polyurethane foam, in particular in a molded foam having a compacted surface zone, known as an integral foam.

The production of polyurethanes, in particular integral foams based on polyurethanes, is generally known. Antistatic polyurethanes according to the invention can be produced by reacting a) organic and/or modified polyisocyanates with (b) at least one relatively high molecular weight compound having at least two reactive hydrogen atoms, c) if appropriate low molecular weight chain extenders and/or crosslinkers, d) an antistatic additive comprising ionic liquids, e) catalysts, f) if appropriate blowing agents and g) if appropriate other additives. For the present purposes, “react” means that the abovementioned components are mixed and the polyurethane is produced from this mixture. It is not intended that a distinction be made between components which react and components which do not react.

The polyisocyanate components (a) used for producing the polyisocyanate polyaddition products of the invention comprise the aliphatic, cycloaliphatic and aromatic divalent or polyvalent isocyanates (constituent a-1) known from the prior art and also any mixtures thereof. Examples are diphenylmethane 4,4′-diisocyanate, the mixtures of monomeric diphenylmethane diisocyanates and homologues of diphenylmethane diisocyanate having more than two rings (polymeric MDI), tetramethylene diisocyanate, hexamethylene diisocyanate (HDI), tolylene diisocyanate (TDI) and mixtures thereof.

Preference is given to using 4,4′-MDI and/or HDI. The 4,4′-MDI which is particularly preferably used can comprise small amounts, up to about 10% by weight, of allophanate- or uretonimine-modified polyisocyanates. Small amounts of polyphenylenepolymethylene polyisocyanate (polymeric MDI) can also be used. The total amount of these high-functionality polyisocyanates should not exceed 5% by weight of the isocyanate used.

The polyisocyanate component (a) is preferably used in the form of polyisocyanate prepolymers. These polyisocyanate prepolymers are obtainable by reacting above-described polyisocyanates (a-1) with polyols (a-2), for example at temperatures from 30 to 100 C, preferably at about 80° C., to give the prepolymer. To prepare the prepolymers used according to the invention, preference is given to using 4,4′-MDI together with urethonimine-modified MDI and commercial polymer polyols based on polyesters, for example derived from adipic acid, or polyethers, for example derived from ethylene oxide or propylene oxide.

Polyols (a-2) are known to those skilled in the art and are described, for example, in “Kunststoffhandbuch, 7, Polyurethane”, Carl Hanser Verlag, 3rd Edition 1993, chapter 3.1.

Prepolymers based on ethers are preferably obtained by reacting polyisocyanates (a-1) with 2- to 3-functional polyoxypropylene polyols and polyoxypropylene-polyoxyethylene polyols. They are usually prepared by the generally known base-catalyzed addition of propylene oxide, either alone or in admixture with ethylene oxide, onto H-functional, in particular OH-functional, starter substances. Starter substances used are, for example, water, ethylene glycol or propylene glycol or glycerol or trimethylolpropane. For example, polyethers as are described below under (b) can be used as component (a-2).

When ethylene oxide/propylene oxide mixtures are used, the ethylene oxide is preferably used in an amount of 10-50% by weight, based on the total amount of alkylene oxide. The alkylene oxides can be incorporated either in blocks or as a random mixture. Particular preference is given to incorporation of an ethylene oxide end block (“EO cap”) in order to increase the content of more reactive primary OH end groups.

Preference is given to using diols based on polyoxypropylene having about 20% by weight of polyoxyethylene units at the end of the chain, so that more than 80% of the OH groups are primary OH groups. The molecular weight of these diols is preferably in the range from 2000 to 4500.

Prepolymers based on esters are preferably obtained by reacting 4,4′-MDI together with uretonimine-modified MDI and commercial polymer polyols based on polyesters, for example derived from adipic acid. Here, modified MDI preferably makes up from 0 to 25% by weight, particularly preferably from 1 to 20% by weight, of the total amount of the MDI used for preparing the prepolymer. The polyol/polyisocyanate ratio is selected so that the NCO content of the prepolymer is from 8 to 28% by weight, preferably from 14 to 26% by weight, particularly preferably from 16 to 22% by weight. To rule out secondary reactions caused by atmospheric oxygen, the reaction can be carried out under inert gas, preferably nitrogen. The polyesterols used preferably have an OH number of from 10 to 100, preferably from 20 to 60. Furthermore, they generally have a theoretical functionality of from 1.9 to 4, preferably from 1.9 to 3.

In one embodiment, the polyesterols described below under the description of the component (b) can be used as component (a-2). Here, it is preferred that the component (a-2) comprises less than 10% by weight of polyetherols, based on the total weight of the component (a-2). In particular, the component (a-2) does not comprise any polyetherols and particularly preferably consists entirely of polyesterols.

In a further embodiment, branched polyesterols are used as component (a-2). The branched polyesterols preferably have a functionality of from >2 to 3, in particular from 2.2 to 2.8. Furthermore, the branched polyesterols preferably have a number average molecular weight of from 500 to 5000 g/mol, particularly preferably from 2000 to 3000 g/mol. With regard to the starting materials (acids and alcohols) used for preparing the branched polyester (a-2), reference is made to what is said below in respect of the component (b).

If appropriate, chain extenders (a-3) can be added in the reaction to form the polyisocyanate prepolymer both in the case of polyether systems and also in the case of polyester systems. Dihydric or trihydric alcohols, preferably branched dihydric or trihydric alcohols having a molecular weight of less than 450 g/mol, particularly preferably less than 400 g/mol, are suitable as chain extenders for the prepolymer (a-3). Preference is given to using dipropylene glycol and/or tripropylene glycol. Adducts of dipropylene glycol and/or tripropylene glycol with alkylene oxides, preferably propylene oxide, are also suitable.

As relatively high molecular weight compounds (b) having at least two reactive hydrogen atoms, it is advantageous to use compounds having a functionality of from 2 to 8 and a molecular weight of from 400 to 12 000. Compounds which have been found to be useful are, for example, polyether polyamines and/or preferably polyols selected from the group consisting of polyether polyols, polyester polyols prepared from alkanedicarboxylic acids and polyhydric alcohols, polythioether polyols, polyesteramides, hydroxyl-comprising polyacetals and hydroxyl-comprising aliphatic polycarbonates or mixtures of at least two of the polyols mentioned. Preference is given to using polyester polyols and/or polyether polyols. In contrast, alkyd resins or polyester molding compositions having reactive, olefinically unsaturated double bonds are unsuitable as relatively high molecular weight compounds (b) having at least two reactive hydrogen atoms.

Suitable polyester polyols can, for example, be prepared from alkanedicarboxylic acids having from 2 to 12 carbon atoms, preferably alkanedicarboxylic acids having from 4 to 6 carbon atoms, or mixtures of alkanedicarboxylic acids and aromatic polycarboxylic acids and polyhydric alcohols, preferably diols having from 2 to 12 carbon atoms, preferably from 2 to 6 carbon atoms, and/or alkylene glycols. Examples of possible alkanedicarboxylic acids are: succinic acid, glutaric acid, adipic acid, suberic acid, azelaic acid, sebacic acid and decanedicarboxylic acid. Suitable aromatic polycarboxylic acids are, for example, phthalic acid, isophthalic acid and terephthalic acid. The alkanedicarboxylic acids can be used either individually or in admixture with one another. The corresponding dicarboxylic acid derivatives such as dicarboxylic esters of alcohols having from 1 to 4 carbon atoms or dicarboxylic anhydrides can also be used in place of the free dicarboxylic acids. Preference is given to using dicarboxylic acid mixtures of succinic, glutaric and adipic acids in weight ratios of, for example, 20-35:35-50:20-32, and in particular adipic acid. Examples of dihydric and polyhydric alcohols, in particular diols or alkylene glycols are: ethanediol, diethylene glycol, 1,2- or 1,3-propanediol, dipropylene glycol, 1,4-butanediol, 1,5-pentanediol, 1,6-hexanediol, 1,10-decanediol, glycerol and trimethylolpropane. Preference is given to using ethanediol, diethylene glycol, 1,4-butanediol, 1,5-pentanediol, 1,6-hexanediol or mixtures of at least two of the diols mentioned, in particular mixtures of 1,4-butanediol, 1,5-pentanediol and 1,6-hexanediol. It is also possible to use polyester polyols derived from lactones, e.g. ε-caprolactone, or hydroxycarboxylic acids, e.g. ω-hydroxycaproic acid.

To prepare the polyester polyols, the mixtures of aromatic and aliphatic dicarboxylic acids and preferably alkanedicarboxylic acids and/or derivatives thereof and polyhydric alcohols can be polycondensed in the absence of catalysts or preferably in the presence of esterification catalysts, advantageously in an atmosphere of inert gases such as nitrogen, helium, argon, etc., in the melt at temperatures of from 150 to 250° C., preferably from 180 to 220° C., if appropriate under reduced pressure to the desired acid number which is advantageously less than 10, particularly preferably less than 2. In a preferred embodiment, the esterification mixture is polycondensed at the abovementioned temperatures to an acid number of from 80 to 30, preferably from 40 to 30, under atmospheric pressure and subsequently under a pressure of less than 500 hPa, preferably from 50 to 150 hPa. Possible esterification catalysts are, for example, iron, cadmium, cobalt, lead, zinc, antimony, magnesium, titanium and tin catalysts in the form of metals, metal oxides or metal salts. However, the polycondensation can also be carried out in the liquid phase in the presence of diluents and/or entrainers such as benzene, toluene, xylene or chlorobenzene to enable the water of condensation to be distilled off azeotropically.

To prepare the polyester polyols, the organic polycarboxylic acids and/or derivatives thereof and polyhydric alcohols are advantageously polycondensed in a molar ratio of from 1:1 to 1:1.8, preferably from 1:1.05 to 1:1.2.

The polyester polyols obtained preferably have a functionality of from 2 to 4, in particular from 2 to 3, and a molecular weight of from 480 to 3000, preferably from 1200 to 3000 and in particular from 1800 to 2500.

Suitable polyether polyols can be prepared by known methods, for example from one or more alkylene oxides having from 2 to 4 carbon atoms in the alkylene radical by anionic polymerization using alkali metal hydroxides such as sodium or potassium hydroxide or alkali metal alkoxides such as sodium methoxide, sodium or potassium ethoxide or potassium isopropoxide as catalysts with addition of at least one starter molecule comprising from 2 to 8 reactive hydrogen atoms in bound form or by cationic polymerization using Lewis acids such as antimony pentachloride, boron fluoride etherate, etc., or bleaching earth as catalysts.

Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures. Possible starter molecules are, for example: water, organic dicarboxylic acids such as succinic acid, adipic acid, phthalic acid and terephthalic acid, aliphatic and aromatic, optionally N-monoalkyl-, N,N- and N,N′-dialkyl-substituted diamines having from 1 to 4 carbon atoms in the alkyl radical, e.g. optionally monoalkyl- and dialkyl-substituted ethylenediamine, diethylenetriamine, triethylenetetramine, 1,3-propylenediamine, 1,3- or 1,4-butylenediamine, 1,2-, 1,3-, 1,4-, 1,5- and 1,6-hexamethylenediamine, phenylenediamines, 2,3-, 2,4- and 2,6-tolylenediamine and 4,4′-, 2,4′- and 2,2′-diaminodiphenylmethane.

Further possible starter molecules are: alkanolamines such as ethanolamine, diethanolamine, N-methylethanolamine and N-ethylethanolamine, N-methyldiethanolamine and N-ethyldiethanolamine and triethanolamine and ammonia. Preference is given to using polyhydric, in particular dihydric to octahydric, alcohols such as ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose.

The polyether polyols, preferably polyoxypropylene polyols and polyoxypropylene-polyoxyethylene polyols, for the production of elastic or semirigid, cellular polyisocyanate polyaddition products have a functionality of preferably from 2 to 4 and in particular 2 and/or 3 and molecular weights of preferably from 1800 to 6000 and in particular from 2400 to 4000 and suitable polyoxytetramethylene glycols have a molecular weight up to about 3500 and for the production of rigid, cellular polyisocyanate polyaddition products, in particular thermosets, have a functionality of preferably from 3 to 8 and in particular from 3 to 6 and a molecular weight of preferably from 400 to 3200 and in particular from 600 to 2400.

Like the polyester polyols, the polyether polyols can be used individually or in the form of mixtures. To produce elastic thermosets, it can be advantageous, for example, to use suitable mixtures of polyether polyols having molecular weights up to 2400 and ones having molecular weights of from 2800 to 4000. Furthermore, they can be mixed with the graft polyether polyols or polyester polyols and also the hydroxyl-comprising polyesteramides, polyacetals, polycarbonates and/or polyether polyamines.

Possible hydroxyl-comprising polyacetals are, for example, the compounds which can be prepared from glycols such as diethylene glycol, triethylene glycol, 4,4′-dihydroxyethoxydiphenyldimethylmethane, hexanediol and formaldehyde. Suitable polyacetals can also be prepared by polymerization of cyclic acetals.

Possible hydroxyl-comprising polycarbonates are ones of the type known per se, which can be prepared, for example, by reacting diols such as 1,3-propanediol, 1,4-butanediol and/or 1,6-hexanediol, diethylene glycol, triethylene glycol or tetraethylene glycol with diaryl carbonates, e.g. diphenyl carbonate, or phosgene.

The polyesteramides include, for example, the predominantly linear condensates obtained from polyfunctional, saturated and/or unsaturated carboxylic acids or their anhydrides and polyfunctional saturated and/or unsaturated amino alcohols or mixtures of polyfunctional alcohols and amino alcohols and/or polyamines.

Suitable polyether polyamines can be prepared from the abovementioned polyether polyols by known methods. Mention may be made by way of example of the cyanoalkylation of polyoxyalkylene polyols and subsequent hydrogenation of the nitrile formed (U.S. Pat. No. 3,267,050) or the partial or complete amination of polyoxyalkylene polyols by means of amines or ammonia in the presence of hydrogen and catalysts (DE 12 15 373).

Further suitable polyols are polymer-modified polyols, preferably polymer-modified polyesterols or polyetherols, particularly preferably graft polyetherols or graft polyesterols. These are in each case a polymer polyol which usually has a content of preferably thermoplastic polymers of from 5 to 50% by weight, preferably from 10 to 45% by weight, particularly preferably from 15 to 25% by weight and in particular from 18 to 22% by weight. These polymer polyesterols are described, for example, in EP-A-250 351 and are usually prepared by free-radical polymerization of suitable olefinic monomers, for example styrene, acrylonitrile, acrylates and/or acrylamide, in a polyesterol serving as graft base. The side chains are generally formed by transfer of the free radicals of growing polymer chains to polyesterols or polyetherols. Apart from the graft copolymer, the polymer polyol comprises predominantly the homopolymers of the olefins dispersed in unchanged polyesterol.

In a preferred embodiment, acrylonitrile, styrene, in particular exclusively styrene, are used as monomers. The monomers are, if appropriate, polymerized in the presence of further monomers, of a macromer, of a moderator and using a free-radical initiator, usually azo or peroxide compounds, in a polyesterol as continuous phase.

During the free-radical polymerization, the macromers are incorporated into the copolymer chain. This results in formation of block copolymers having a polyester block and a polyacrylonitrile-styrene block which act as phase compatibilizers at the interface of the continuous phase and disperse phase and suppress agglomeration of the polymer polyesterol particles. The proportion of macromers is usually from 1 to 15% by weight, based on the total weight of the monomers used for preparing the polymer polyol.

The proportion of polymer polyol is preferably greater than 5% by weight, based on the total weight of the component (b). The polymer polyols can, for example, be comprised in an amount of from 30 to 90% by weight or from 55 to 80% by weight, based on the total weight of the component (b). The polymer polyol is particularly preferably a polymer polyesterol or polyetherol.

The polyisocyanate polyaddition products and preferably integral foams comprising urethane groups or urethane and isocyanurate groups can be produced with or without concomitant use of chain extenders and/or crosslinkers. However, the addition of chain extenders, crosslinkers or, if appropriate, mixtures thereof can prove to be advantageous for modifying the mechanical properties, e.g. the hardness. Chain extenders and/or crosslinkers used are diols and/or triols having molecular weights of less than 400, preferably of from 60 to 300 and in particular from 60 to 150. Possible diols/triols are, for example, aliphatic, cycloaliphatic and/or araliphatic diols having from 2 to 14, preferably from 2 to 10, carbon atoms, e.g. ethylene glycol, 1,3-propanediol, 1,10-decanediol, o-, m-, p-dihydroxycyclohexane, diethylene glycol, dipropylene glycol and preferably 1,4-butanediol, 1,6-hexanediol and bis(2-hydroxyethyl)hydroquinone, triols such as 1,2,4-, 1,3,5-trihydroxycyclohexane, glycerol and trimethylolpropane and low molecular weight hydroxyl-comprising polyalkylene oxides based on ethylene oxide and/or 1,2-propylene oxide and the abovementioned diols and/or triols as starter molecules.

To produce cellular polyurethane-polyurea elastomers, it is possible to employ secondary aromatic diamines, primary aromatic diamines, 3,3′-dialkyl- and/or 3,3′,5,5′-tetraalkyl-substituted diaminodiphenylmethanes as chain extenders or crosslinkers in addition to the abovementioned diols and/or triols or in admixture with these.

The abovementioned chain extenders and/or crosslinkers (c) can be used individually or as mixtures of identical or different types of compound.

If chain extenders, crosslinkers or mixtures thereof are employed, they are advantageously used in amounts of from 1 to 60% by weight, preferably from 4 to 50% by weight and in particular from 5 to 40% by weight, based on the weight of the components (b) and (c).

The reaction of the components a) and (b) and, if appropriate, (c) is carried out in the presence of an antistatic additive (d) according to the invention.

As catalysts (e) for producing the polyisocyanate polyaddition products, in particular cellular plastics, by the polyisocyanate polyaddition process, preference is given to using compounds which strongly accelerate the reaction of the hydroxyl-comprising compounds of the component (b) and, if present, (c) with the organic, if appropriate modified polyisocyanates (a). Possible catalysts are organic metal compounds, preferably organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates such as bismuth(III) neodecanoate, bismuth 2-ethylhexanoate and bismuth octanoate or mixtures thereof. The organic metal compounds are used either alone or preferably in combination with strongly basic amines. Mention may be made of, for example, amidines such as 2,3-dimethyl-3,4,5,6-tetrahydropyrimidine, tertiary amines such as triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, bis(dimethylaminoethyl)ether, bis(dimethylaminopropyl)urea, dimethylpiperazine, 1,2-dimethylimidazole, 1-azabicyclo[3.3.0]octane and preferably 1,4-diazabicyclo[2.2.2]octane and alkanolamine compounds such as triethanolamine, triisopropanolamine, N-methyldiethanolamine and N-ethyldiethanolamine and dimethylethanolamine. If the component (b) is an ester, preference is given to using exclusively amine catalysts.

Further catalysts which may come into consideration, especially when a relatively large polyisocyanate excess is used, are: tris(dialkylaminoalkyl)-s-hexahydrotriazines, preferably tris(N,N-dimethylaminopropyl)-s-hexahydrotriazines, tetraalkylammonium hydroxides such as tetramethylammonium hydroxide, alkali metal hydroxides such as sodium hydroxide and alkali metal alkoxides such as sodium methoxide and potassium isopropoxide and also alkali metal salts of long-chain fatty acids having from 10 to 20 carbon atoms and, if appropriate, lateral OH groups. Preference is given to using from 0.001 to 5% by weight, in particular from 0.05 to 2% by weight, of catalyst or catalyst combination, based on the weight of the component (b).

Furthermore, blowing agents (f) are usually present in the production of cellular polyurethanes. These blowing agents preferably comprise water (referred to as constituent (f-1)). It is possible to use generally known chemically or physically acting compounds (these are referred to as constituent (f-2)) in addition to or in place of water (f-1) as blowing agents (f). Examples of physical blowing agents are inert (cyclo)aliphatic hydrocarbons having from 4 to 8 carbon atoms which vaporize under the conditions of polyurethane formation. Furthermore, fluorinated hydrocarbons such as Solkane® 365 mfc can also be used as blowing agents. In a preferred embodiment, a mixture of these blowing agents comprising water is used as blowing agent, but water is particularly preferably used as sole blowing agent.

In a preferred embodiment, water (f-1) is used in an amount of from 0.1 to 2% by weight, preferably from 0.2 to 1.5% by weight, particularly preferably from 0.3 to 1.2% by weight, in particular from 0.4 to 1% by weight, based on the total weight of the components (b) and if present (c).

In a further preferred embodiment, microspheres comprising physical blowing agent are added as additional blowing agent (f-2) in the reaction of the components (a), (b) and, if appropriate, (c). The microspheres can also be used in admixture with the abovementioned additional blowing agents (f-2).

The microspheres (f-2) usually comprise a shell of thermoplastic polymer and have a core filled with a liquid, low-boiling substance based on alkanes. The production of such microspheres is described, for example, in U.S. Pat. No. 3,615,972. The microspheres generally have a diameter of from 5 to 50 μm. Examples of suitable microspheres can be obtained under the trade name Expancell® from Akzo Nobel.

The microspheres are generally added in an amount of from 0.5 to 5%, based on the total weight of the components (b), if present (c), and (f).

If appropriate, auxiliaries and/or additives (f) can also be added to the reaction mixture for producing the polyisocyanate polyaddition products, in particular the cellular plastics, by the polyisocyanate polyaddition process. Examples which may be mentioned are surface-active substances, foam stabilizers, cell regulators, mold release agents, fillers, dyes, pigments, flame retardants, hydrolysis inhibitors, fungistatic and bacteriostatic substances.

Possible surface-active substances are, for example, compounds which serve to aid the homogenization of the starting materials and may, if appropriate, also be suitable for regulating the cell structure. Examples which may be mentioned are emulsifiers such as the sodium salts of castor oil sulfates or fatty acids and also salts of fatty acids with amines, e.g. diethylamine oleate, diethanolamine stearate, diethanolamine ricinoleate, salts of sulfonic acids, e.g. alkali metal or ammonium salts of dodecylbenzene disulfonic or dinaphthylmethanedisulfonic acid and ricinoleic acid; foam stabilizers such as siloxane-oxalkylene copolymers and other organopolysiloxanes, ethoxylated alkylphenols, ethoxylated fatty alcohols, paraffin oils, castor oil or ricinoleic esters, Turkey red oil and peanut oil and cell regulators such as paraffins, fatty alcohols and dimethylpolysiloxanes. Oligomeric acrylates having polyoxyalkylene and fluoroalkane radicals as side groups are also suitable for improving the emulsifying action, the cell structure and/or for stabilizing the foam. The surface-active substances are usually employed in amounts of from 0.01 to 5 parts by weight, based on 100 parts by weight of the component (b).

As suitable mold release agents, mention may be made by way of example of: reaction products of fatty acid esters with polyisocyanates, salts of polysiloxanes comprising amino groups and fatty acids, salts of saturated or unsaturated (cyclo)aliphatic carboxylic acids having at least 8 carbon atoms and tertiary amines and also, in particular, internal mold release agents such as carboxylic esters and/or carboxamides prepared by esterification or amidation of a mixture of montanic acid and at least one aliphatic carboxylic acid having at least 10 carbon atoms by means of at least bifunctional alkanolamines, polyols and/or polyamines having molecular weights of from 60 to 400 (EP-A-153 639), mixtures of organic amines, metal salts of stearic acid and organic monocarboxylic and/or dicarboxylic acids or their anhydrides (DE-A-3 607 447) or mixtures of an imino compound, the metal salt of a carboxylic acid and, if appropriate, a carboxylic acid (U.S. Pat. No. 4,764,537).

For the purposes of the present invention, fillers, in particular reinforcing fillers, are the customary organic and inorganic fillers, reinforcing materials, weighting agents, agents for improving the abrasion behavior in paints, coating agents, etc., known per se. Specific examples which may be mentioned are: inorganic fillers such as siliceous minerals, for example sheet silicates such as antigorite, serpentine, hornblendes, amphiboles, chrisotile, talc; metal oxides such as kaolin, aluminum oxides, titanium oxides and iron oxides, metal salts such as chalk, barite and inorganic pigments such as cadmium sulfide, zinc sulfide and also glass, etc. Preference is given to using kaolin (China clay), aluminum silicate and coprecipitates of barium sulfate and aluminum silicate and also natural and synthetic fibrous minerals such as wollastonite, metal fibers and in particular glass fibers of various lengths which may, if appropriate, be coated with a size. Possible organic fillers are, for example: carbon black, melamine, rosin, cyclopentadienyl resins and graft polymers and also cellulose fibers, polyamide, polyacrylonitrile, polyurethane, polyester fibers based on aromatic and/or aliphatic dicarboxylic esters and in particular carbon fibers.

The inorganic and organic fillers can be used individually or as mixtures and are advantageously added to the reaction mixture in amounts of from 0.5 to 50% by weight, preferably from 1 to 40% by weight, based on the weight of the components (a) to (c), although the content of mats, nonwovens and woven fabrics of natural and synthetic fibers can reach values of up to 80% by weight.

Suitable flame retardants are, for example, tricresyl phosphate, tris-2-chloroethyl phosphate, trischloropropyl phosphate and tris-2,3-dibromopropyl phosphate.

Apart from the abovementioned halogen-substituted phosphates, it is also possible to use inorganic flame retardants such as red phosphorus, aluminum oxide hydrate, antimony trioxide, arsenic oxide, ammonium polyphosphate and calcium sulfate or cyanuric acid derivatives such as melamine or mixtures of at least two flame retardants such as ammonium polyphosphates and melamine and also, if appropriate, starch, e.g. maize starch, for making the polyisocyanate polyaddition products flame resistant. In general, it has been found to be advantageous to use from 5 to 50 parts by weight, preferably from 5 to 25 parts by weight, of the flame retardants mentioned per 100 parts by weight of the component (b).

To produce the cellular plastics comprising urea and/or preferably urethane groups, the organic polyisocyanates (a), relatively high molecular weight compounds having at least two reactive hydrogen atoms (b) and, if appropriate, chain extenders and/or crosslinkers (c) are reacted in such amounts that the equivalence ratio of NCO groups of the polyisocyanates (a) to the sum of the reactive hydrogen atoms of the components (b) and, if present (c) and (f) is 0.85-1.25:1, preferably 0.90-1.15:1. If the cellular plastics comprise at least some bound isocyanurate groups, it is usual to employ a ratio of NCO groups of the polyisocyanates (a) to the sum of the reactive hydrogen atoms of the component (b) and, if present, (c) and (f) of 1.5-20:1, preferably 1.5-8:1. A ratio of 1:1 corresponds to an isocyanate index of 100.

The cellular plastics comprising polyisocyanate polyaddition products, preferably cellular elastomers or in particular polyurethane foams, are advantageously produced by the one-shot process, for example with the aid of the reaction injection molding technique, the high-pressure technique or the low-pressure technique, in open or closed molds, for example metallic molds, e.g. of aluminum, cast iron or steel. It has been found to be particularly advantageous to employ the two-component process and to combine the formative components (b), (d), (e) and, if appropriate, (c) and (f) to form the component (A) and to use the organic polyisocyanates, modified polyisocyanates (a) or mixtures of the polyisocyanates mentioned and, if appropriate, blowing agents (d) as component (B).

The starting components are mixed at a temperature of from 15 to 90° C., preferably from 20 to 50° C., and introduced into the open mold or, if appropriate, under superatmospheric pressure into the closed mold. Mixing can, as has been mentioned above, be carried out mechanically by means of a stirrer or a stirring screw or under high pressure by the countercurrent injection method. The mold temperature is advantageously from 20 to 90° C., preferably from 30 to 60° C. and in particular from 45 to 50° C.

In preferred embodiments, the cellular polyurethanes, in particular cellular elastomers, are produced by means of the reaction injection molding technique in a closed mold and the moldings having a compacted surface zone and a cellular core are produced in a closed mold with compaction at a degree of compaction of from 1.5 to 8.5, preferably from 2 to 6.

The cellular elastomers produced by the process of the invention and the corresponding integral foams have densities of from about 0.45 to 1.2 g/cm³, preferably from 0.45 to 0.85 g/cm³, with the density of filler-comprising products being able to reach higher values, e.g. up to 1.4 g/cm³ and more. Moldings composed of such antistatic, cellular elastomers are mainly used between two ?? bodies between which static charging is to be prevented, for example in load-bearing or damping elements such as rollers, damping elements, floor coverings and floor mats for office and working areas, films, automobile interior components such as floor mats, steering wheels and armrests, mattresses for the surgical sector, armrests for chairs which are used, for example, in the production of electronic components, or shoe soles, with these elements being intended to prevent static charging. The present invention therefore comprises rollers, damping elements, floor coverings, films and automobile interior components comprising an antistatic polyurethane according to the invention. In particular, the moldings of the invention are used as outsole and/or throughsole on shoes, especially of antistatic safety shoes. The invention therefore also provides a shoe sole comprising an antistatic polyurethane as throughsole and/or outsole and a safety shoe conforming to DIN EN 20344-1 which has a shoe sole according to the invention.

Furthermore, flexible elastic and semirigid foams produced by the process of the invention and also the corresponding integral foams can be obtained with a density of from 0.02 to 0.45 g/cm³, with the densities of the flexible elastic foams preferably being from 0.025 to 0.24 g/cm³ and in particular from 0.03 to 0.1 g/cm³. The overall densities of the semirigid foams and integral foams are preferably from 0.2 to 0.9 g/cm³ and in particular from 0.35 to 0.8 g/cm³. These can be used, for example, in automobile interiors.

Compact antistatic polyurethanes and antistatic thermoplastic polyurethanes are preferably used as shoe soles, in particular as outsoles, rollers, films or floor coverings.

The antistatic polymers of the invention, in particular the cellular polyisocyanate addition products, have a volume resistance of 10⁷ Ω/cm and less, preferably 5*10⁶ Ω/cm and less and in particular 1*10⁶ Ω/cm and less, at an addition of only 2.5% by weight, based on the total weight of the foam. Customary adaptations of the formulation, e.g. adaptation of the proportion of crosslinker, make it possible to obtain mechanical parameters such as rebound resilience in accordance with DIN 53512, tensile strength and elongation in accordance with DIN 53504, Shore A hardness in accordance with DIN 53505, tear propagation resistance in accordance with DIN 53507, long-term flexural properties in accordance with DIN 53543 and swelling in accordance with DIN EN 344-1 of polyisocyanate polyaddition products comprising ionic liquids, even at additions of 10% by weight of ionic liquids, based on the total weight of the components (a) to (g), which are essentially the same as those obtained without addition of the ionic liquid. Furthermore, the reaction-specific parameters such as cream times, full rise times and buckling times in systems comprising an ionic liquid in a proportion by mass of up to 10% by weight, based on the total weight of the components (a) to (g), are, after adaptation of the systems, also essentially unchanged compared to these parameters of customary systems without antistatic additives. Finally, the volume resistance of the polyisocyanate polyaddition products of the invention is surprisingly independent of aging, in particular aging in the hydrolysis test at 70° C. and 95% relative humidity in accordance with DIN 53543 or EN ISO 2440. The advantageous properties of the polymers of the invention are illustrated in the following examples.

### EXAMPLES

Starting out from the starting materials indicated in Table 1, foams having a density of from 260 to 300 g/l were produced. For this purpose, the components were mixed and injected into an open mold:

TABLE 1
Overview of systems

| | Parts by |
|---|---|
| | weight |
| A component | |
| Polyol | 84.16 |
| KV | 7.82 |
| Stabilizer 1 | 0.48 |
| Stabilizer 2 | 0.29 |
| Water | 0.45 |
| K | 1.80 |
| IL 1-6 or AS | 5.00 |
| B component | |
| Iso 187/3 ® | 100 |

In the table, the items have the following meanings:
Polyol: Polyester polyol based on adipic acid (ADA), 1,4-butanediol (B14) and ethylene glycol (EG)
KV: Monoethylene glycol
Stabilizer 1: Tegostab B8443 ® (Degussa)
Stabilizer 2: Elastostab H01 ® (BASF)
K: Amine catalyst, Lupragen N 203 ® (BASF)
AS1: Inorganic antistatic Catafor MS/T ® (Rhodia)
AS2: Organic antistatic Catafor F ® (Rhodia)
IL 1: 1-Ethyl-3-methylimidazolium methylsulfonate
IL 2: 1-Ethyl-3-methylimidazolium dicyanamide
IL 3: 1-Butyl-3-methylimidazole hexafluorophosphate
IL 4: 1-Ethyl-3-methylimidazolium ethylsulfate
IL 5: 1-Ethyl-3-methylimidazolium thiocyanate
ISO 187/3 ®: Isocyanate prepolymer from Elastogran based on 4,4′-MDI, polyester polyols and, if appropriate, addition of low molecular weight diols, NCO content = 16.0%.

AS1 and 2 are antistatic additives from the prior art which were tested in Comparative Experiments C1 and C2. In the case of Comparative Experiment C3, no antistatic additive was added. Experiments 1 to 5 show the results for polyurethane foams according to the invention which comprise one of the ionic liquids IL 1 to IL5 as antistatic additive. The volume resistances measured and the long-term action of the antistatic additives on aging in the hydrolysis test are shown in Table 2. In the hydrolysis test, the article to be tested is stored at 70° C. and 95% relative atmospheric humidity for the time indicated.

TABLE 2
Overview of antistatic properties and long-term action

| | | Resistance | Resistance | Resistance |
|---|---|---|---|---|
| | Resistance | [Ω/cm] after | [Ω/cm] after | [Ω/cm] after |
| | [Ω/cm] after | hydrolysis | hydrolysis | hydrolysis |
| | production | for 1 day | for 7 days | for 14 days |
| Comparison 1 | 6*10⁷ | 6*10⁷ | 2*10⁷ | 5*10⁷ |
| (AS1) | | | | |
| Comparison 2 | 5*10⁶ | 5*10⁶ | 5*10⁸ | 7*10⁸ |
| (AS2) | | | | |
| Comparison 3 | 8*10⁸ | 4*10⁸ | 4*10⁸ | 2*10⁸ |
| (no additive) | | | | |
| Experiment 1 | 4*10⁶ | 2*10⁶ | 4*10⁶ | 6*10⁶ |
| (IL 1) | | | | |
| Experiment 2 | 6*10⁵ | 4*10⁵ | 1*10⁶ | 5*10⁵ |
| (IL 2) | | | | |
| Experiment 3 | 6*10⁵ | 7*10⁵ | 8*10⁵ | 1*10⁵ |
| (IL 3) | | | | |
| Comparison 4 | 3*10⁶ | 1*10⁶ | 2*10⁶ | 7*10⁵ |
| (IL 4) | | | | |
| Comparison 5 | 1*10⁶ | 4*10⁵ | 3*10⁵ | 2*10⁵ |
| (IL 5) | | | | |

It can be seen from Table 2 that at a uniform addition of 5% by weight of antistatic additive, the volume resistance when using known antistatic additives (Comparative Experiments 1 and 2) is higher than when using ionic liquids (Experiments 1 to 5). Furthermore, it can be seen that the volume resistance for systems in which the known antistatic additive AS1 is used is greatly increased compared to systems according to the invention, which demonstrates the low efficiency, and that the volume resistance for systems in which another known antistatic additive AS2 is used increases greatly in the hydrolysis test and after 14 days in the hydrolysis test reaches approximately the value for a foam without antistatic additive. Such behavior is not observed when ionic liquids are used as antistatic additives.

Experiments 6, 7 and 8 show the effects of the antistatic additives on the reaction-specific and mechanical properties. Starting out from the starting materials indicated in Table 3, foams having a free-foam density of from 260 to 300 g/l were produced. For this purpose, the components were mixed and injected into an open mold. The mechanical parameters were determined on test plates at doubled compaction:

TABLE 3

| | Experiment 6 | Experiment 7 | Experiment 8 |
|---|---|---|---|
| | [parts by weight] | [parts by weight] | [parts by weight] |
| A component: | | | |
| Polyol | 89 | 77.61 | 76.3 |
| KV | 8 | 11.7 | 11.5 |
| Stabilizer 1 | 0.28 | 0.29 | 0.28 |
| Stabilizer 2 | 0.48 | 0.48 | 0.48 |
| Water | 0.45 | 0.42 | 0.44 |
| K | 1.8 | 1.5 | 1.5 |
| IL 5 | — | 8 | 6 |
| AS2 | | | 3.5 |
| B component | | | |
| Iso 187/3 ® | 88 | 73 | 70 |

The characteristics of Experiments 6 to 8 are shown in Table 4.

| | Experiment 6 | Experiment 7 | Experiment 8 |
|---|---|---|---|
| Cream time [s] | 13 | 11 | 12 |
| Shore A | 56 | 53 | 55 |
| Resistance [Ω/cm] | 9*10⁸ | 6*10⁵ | 8*10⁵ |
| Rebound resilience | 32 | 37 | 38 |
| [%] | | | |
| Tear propagation | 13.9 | 13.1 | 13.0 |
| resistance [N/mm²] | | | |
| Tensile strength | 4.1 | 4.6 | 5.1 |
| [N/mm²] | | | |
| Elongation [%] | 392 | 371 | 405 |

It can be seen from Table 4 that the system properties and also the other product properties remain essentially unchanged when ionic liquids are added to reduce the volume resistance.

The values were determined as follows:

Rebound resilience in accordance with DIN 53512

Tensile strength and elongation in accordance with DIN 53504,

Shore A hardness in accordance with DIN 53505,

Tear propagation resistance in accordance with DIN 53507,

Long-term flexural properties in accordance with DIN 53543

1. A polyurethane comprising an ionic liquid.

2. The polyurethane according to claim 1, wherein the ionic liquid is not covalently bound to the polymer matrix.

3. The polyurethane according to claim 1 or 2, wherein the ionic liquid is liquid at room temperature.

4. The polyurethane according to claim to 3, wherein the cation used for the ionic liquid is a cation selected from the group consisting of 1,2,3-trimethylimidazolium, 1,3,4,5-tetramethylimidazolium, 1,3,4-dimethylimidazolium, 1,3,4-trimethylimidazolium, 1,3-dibutyl-2-methylimidazolium, 1,3-dibutylimidazolium, 1,2-dimethylimidazolium, 1,3-dimethylimidazolium, 1-benzyl-3-methylimidazolium, 1-butyl-2,3-dimethylimidazolium, 1-butyl-2-ethyl-5-methylimidazolium, 1-butyl-2-ethylimidazolium, 1-butyl-2-methylimidazolium, 1-butyl-3,4,5-trimethylimidazolium, 1-butyl-3,4-dimethylimidazolium, 1-butyl-3-ethylimidazolium, 1-butyl-3-methylimidazolium, 1-butyl-4-methylimidazolium, 1-butylimidazolium, 1-decyl-3-methylimidazolium, 1-dodecyl-3-methylimidazolium, 1-ethyl-2,3-dimethylimidazolium, 1-ethyl-3-methylimidazolium, 1-hexadecyl-2,3-dimethylimidazolium, 1-hexadecyl-3-methylimidazolium, 1-hexyl-2,3-dimethylimidazolium, 1-hexyl-3-methylimidazolium, 1-methyl-2-ethylimidazolium, 1-methyl-3-octylimidazolium, 1-methylimidazolium, 1-pentyl-3-methylimidazolium, 1-phenylpropyl-3-methylimidazolium, 1-propyl-2,3-dimethylimidazolium, 1-tetradecyl-3-methylimidazolium, 2,3-dimethylimidazolium, 2-ethyl-3,4-dimethylimidazolium, 3,4-dimethylimidazolium, 1,2-dimethylpyridinium, guanidinium, hexamethylguanidinium, N,N,N′,N′-tetramethyl-N″-ethylguanidinium, N-pentamethyl-N-isopropylguanidinium, N-pentamethyl-N-propylguanidinium, benzyltriphenylphosphonium, tetrabutylphosphonium, trihexyl(tetradecyl)phosphonium and triisobutyl(methyl)phosphonium.

5. The polyurethane according to any of claims 1 to 4, wherein the anion used for the ionic liquid is an anion selected from the group consisting of acetate, bis(2,4,4-trimethylpentyl)phosphinate, bis(malonato)borate, bis(oxalato)borate, bis(pentafluoroethyl)phosphinate, bis(phthalato)borate, bis(salicylato)borate, bis(trifluoromethanesulfonyl)imidate, bis(trifluoromethanesulfonyl)methane, bis(trifluoromethyl)imidate, borate, bromide, bromoaluminates, carbonate, chloroaluminates, decylbenzenesulfonate, dichlorocuprate, dicyanamide, didecylbenzenesulfonate, didodecylbenzenesulfonate, diethylphosphate, dihydrogenphosphate, dodecylbenzenesulfonate, ethylsulfate, ethylsulfonate, fluoride, hexafluorophosphate, hydrogencarbonate, hydrogenphosphate, hydrogensulfate, hydrogensulfite, iodide, methylsulfate, methylsulfonate, nitrate, nitrite, phosphate, sulfite, tetracyanoborate, tetrafluoroborate, tetrakis(hydrogensulfato)borate, tetrakis(methylsulfonato)borate, thiocyanate, tosylate, trichlorozincate, trifluoroacetate, trifluoromethylsulfonate, tris(heptafluoropropyl)trifluorophosphate, tris(nonafluorobutyl)trifluorophosphate, tris(pentafluoroethyl)trifluorophosphate, tris(pentafluoroethylsulfonyl)trifluorophosphate.

6. The polyurethane according to any of claims 1 to 3, wherein the ionic liquid is selected from the group consisting of 1-ethyl-3-methylimidazolium methylsulfonate, 1-ethyl-3-methylimidazolium dicyanamide, 1-ethyl-3-methylimidazolium ethylsulfate, 1-ethyl-3-methylimidazolium thiocyanate, 1-ethyl-3-methylimidazolium tetrafluoroborate, 1-ethyl-3-methylimidazolium hexafluorophosphate, 1-ethyl-3-methylimidazolium diethylphosphate, 1-ethyl-3-methylimidazolium bromide, 1-ethyl-3-methylimidazolium p-toluenesulfonate, 1-butyl-3-methylimidazolium methanesulfonate, 1-butyl-3-methylimidazolium dicyanamide, 1-butyl-3-methylimidazolium ethylsulfate, 1-butyl-3-methylimidazolium thiocyanate, 1-butyl-3-methylimidazolium dimethylphosphate, 1-butyl-3-methylimidazolium bromide, 1-butyl-3-methylimidazolium p-toluenesulfonate, 1-butyl-3-methylimidazolium tetrafluoroborate and 1-butyl-3-methylimidazolium hexafluorophosphate.

7. The polyurethane according to any of claims 1 to 6, wherein the ionic liquid is comprised in an amount of from 0.001 to 30% by weight, based on the total weight of the polymer.

8. A roller comprising a polyurethane according to any of claims 1 to 7.

9. A film comprising a polyurethane according to any of claims 1 to 7.

10. A floor covering comprising a polyurethane according to any of claims 1 to 7.

11. The polyurethane according to any of claims 1 to 7 which is a cellular polyurethane.

12. An automobile interior component comprising a cellular polyurethane according to claim 11.

13. An antistatic shoe sole comprising a polyurethane according to any of claims 1 to 7 or claim 11.

14. A safety shoe comprising an antistatic shoe sole according to claim 13 as throughsole and/or as outsole.

15. A process for producing an antistatic polyisocyanate polyaddition product, which comprises reacting
a) organic and/or modified polyisocyanates with
b) at least one relatively high molecular weight compound having at least two reactive hydrogen atoms and
c) if appropriate low molecular weight chain extenders, in the presence of
d) an antistatic additive comprising an ionic liquid,
e) catalysts,
f) if appropriate blowing agents and
g) if appropriate other additives.

16. The use of ionic liquids as antistatic additive for polyurethanes.
